(19) United States
(12) Patent Application Publication
(10) Pub. No.: US 2025/0130758 A1
(43) Pub. Date: Apr. 24, 2025

(54) SELECTING CANDIDATE DEVICES

(71) Applicant: Nokia Technologies Oy, Espoo (FI)

(72) Inventors: Ting DANG, Cambridge (GB); Khaldoon AL-NAIMI, Cambridge (GB); Ashok Samraj THANGARAJAN, Cambridge (GB); Andrea FERLINI, Cambridge (GB); Yang LIU, Cambridge (GB); Alessandro MONTANARI, Cambridge (GB)

(21) Appl. No.: 18/915,223

(22) Filed: Oct. 14, 2024

(30) Foreign Application Priority Data
Oct. 18, 2023 (GB) 2315947.8

(51) Int. Cl. G06F 3/16

(52) U.S. Cl. CPC G06F 3/16

(57) ABSTRACT

Examples of the disclosure relate to selecting candidate devices for connecting with one or more portable devices. In examples of the disclosure two or more candidate devices that satisfy location criteria are identified. Microphones of a portable device are used to determine a location of a sound source relative to the at least one portable device and the location of the sound source is compared with respective locations for the two or more candidate devices. A candidate device for connecting to the at least one portable device is selected based, at least in part, on the comparison between the location of the sound source and a location for the selected candidate device.

### TECHNOLOGICAL FIELD

Examples of the disclosure relate to selecting candidate devices. Some relate to selecting candidate devices for connecting with one or more portable devices.

### BACKGROUND

Portable devices such as earbuds or smart phones can be connected to other devices. The connection can comprise a wireless communication link that enables content or other information to be shared between the respective devices. For instance, a portable device such as earbuds or a smartphone can be connected to another device to enable audio content, or any other types of content, to be played back to a user of the portable device. If there are multiple devices in the location of the portable device then the portable device has to select which of the devices to connect to

### BRIEF SUMMARY

According to various, but not necessarily all, examples of the disclosure there is provided an apparatus comprising means for:
determining locations for two or more candidate devices;
identifying two or more candidate devices that satisfy location criteria;
using microphones of at least one portable device to determine a location of a sound source relative to the at least one portable device;
comparing the location of the sound source and respective locations for the two or more candidate devices; and
selecting a candidate device for connecting to the at least one portable device based, at least in part, on the comparison between the location of the sound source and the respective locations for the two or more candidate devices.

A candidate device may be selected if the location of the candidate device corresponds with the location of the sound source.

The candidate device may be selected based, at least in part, on information obtained from one or more additional sensor.

Information obtained from the one or more additional sensor may be used if there is not a sufficient match between the location of the sound source and the respective locations for the two or more candidate devices.

The one or more additional sensor may comprise at least one of:
a camera; or
a motion sensor.

The means may be for connecting the selected candidate device to the at least one portable device to enable the selected candidate device to provide audio content to the at least one portable device.

The location criteria may be determined relative to the at least one portable device.

The location criteria may comprise at least one of:
a proximity threshold to the at least one portable device;
a proximity threshold between respective candidate devices.

The at least one portable device may be configured to provide audio outputs.

The at least one portable device may be a wearable device.

The wearable device may be at least one of:
ear buds;
a head mounted display; or
headphones.

According to various, but not necessarily all, examples of the disclosure there is provided a method comprising:
determining locations for two or more candidate devices;
identifying two or more candidate devices that satisfy location criteria;
using microphones of at least one portable device to determine a location of a sound source relative to the at least one portable device;
comparing the location of the sound source and respective locations for the two or more candidate devices; and
selecting a candidate device for connecting to the at least one portable device based, at least in part, on the comparison between the location of the sound source and the respective locations for the two or more candidate devices.

According to various, but not necessarily all, examples of the disclosure there is provided a computer program comprising instructions which, when executed by an apparatus, cause the apparatus to perform at least:
determining locations for two or more candidate devices;
identifying two or more candidate devices that satisfy location criteria;
using microphones of at least one portable device to determine a location of a sound source relative to the at least one portable device;
comparing the location of the sound source and respective locations for the two or more candidate devices; and
selecting a candidate device for connecting to the at least one portable device based, at least in part, on the comparison between the location of the sound source and the respective locations for the two or more candidate devices.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

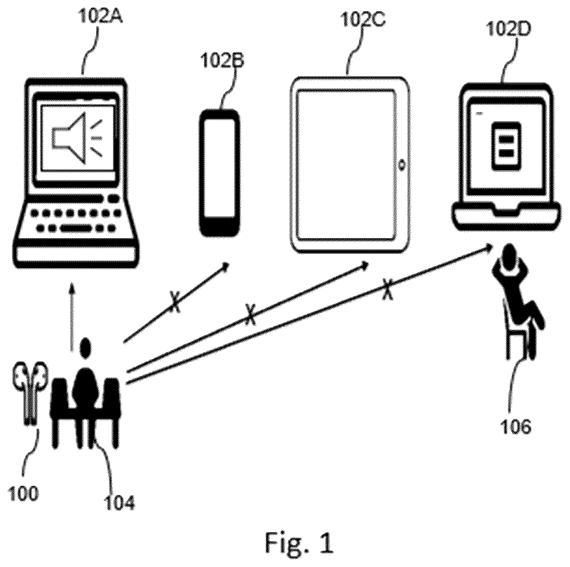

FIG. 1 shows a portable device and multiple candidate devices;

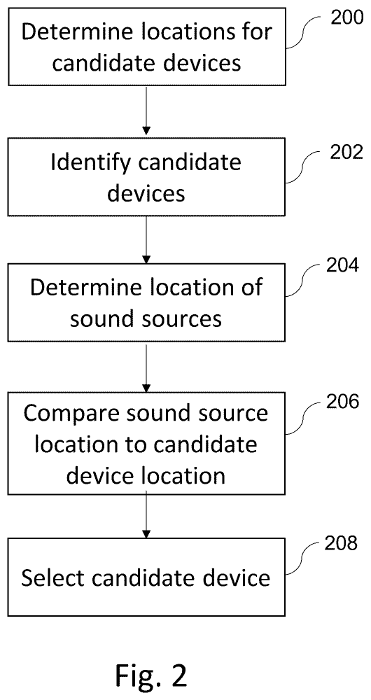

FIG. 2 shows an example method;

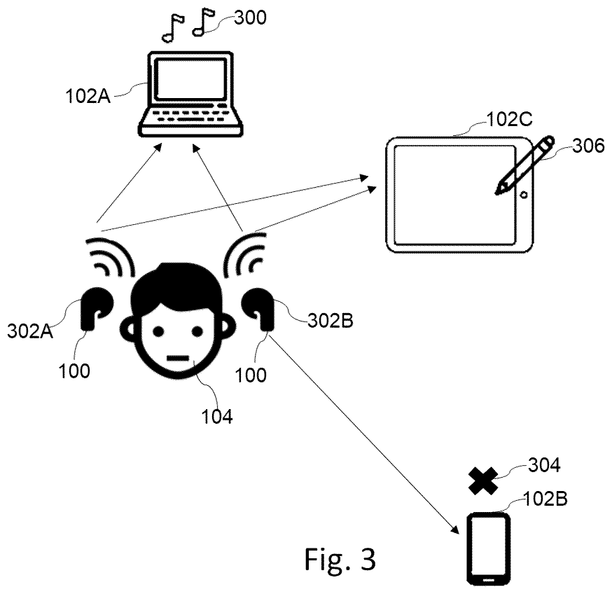

FIG. 3 shows an example use case scenario;

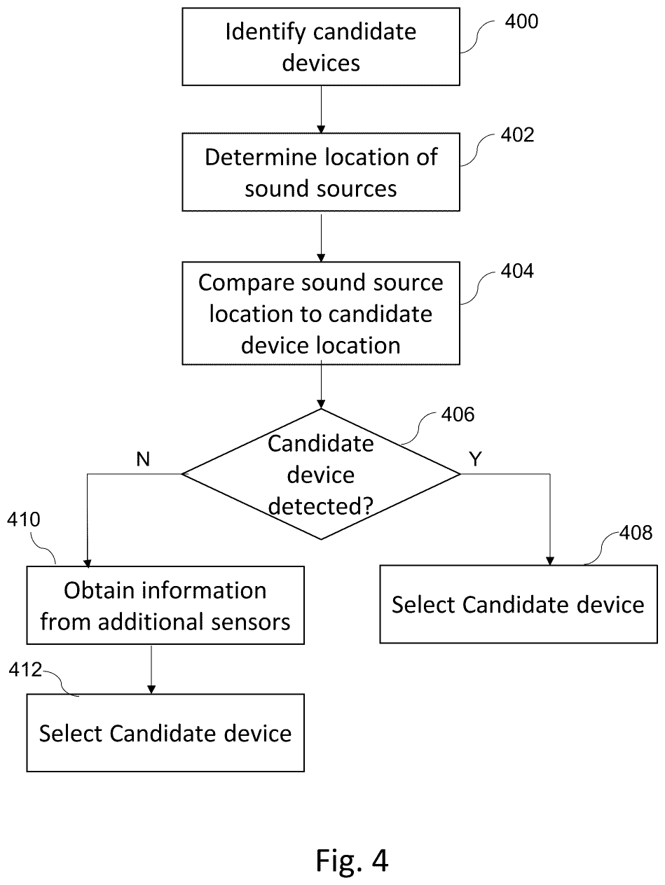

FIG. 4 shows an example method;

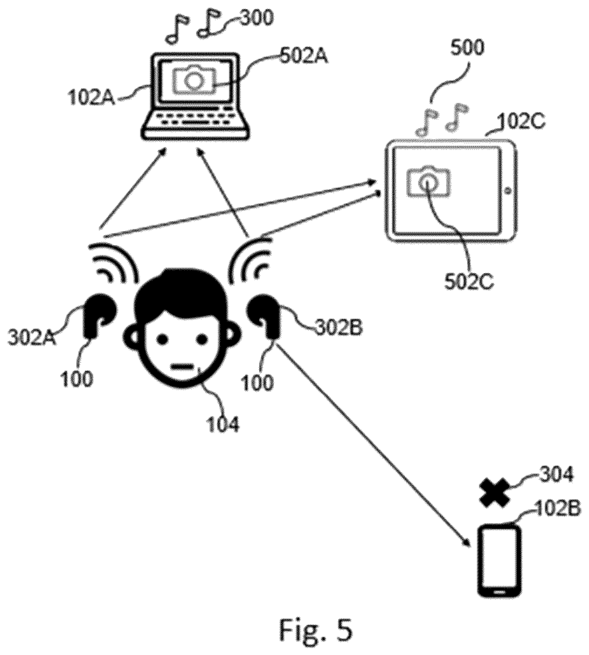

FIG. 5 shows an example use case scenario; and

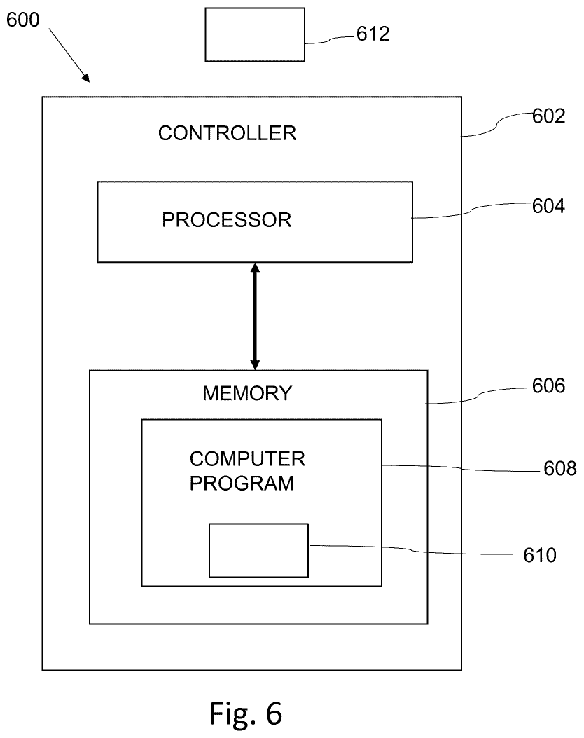

FIG. 6 shows an example apparatus.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Corresponding reference numerals are used in the figures to designate corresponding features. For clarity, all reference numerals are not necessarily displayed in all figures.

### DETAILED DESCRIPTION

FIG. 1 shows a portable device 100 and multiple candidate devices 102A-102D.

The portable device 100 can be used by a user 104 to consume content. The content could comprise audio, images, video or any other suitable type of content.

The portable device 100 can comprise any device that can be moved by the user 104. In some examples the portable device 100 can be a wearable device that can be worn, or otherwise attached to the user 104. In the example of FIG. 1 the portable device 100 comprises earbuds. The earbuds can be worn by a user and used to listen to audio content. Other types of portable device 100 can be used in other examples. For instance, a smart phone could be carried or held by the user 104.

The portable device 100 comprises output means that enable the content to be played back to the user. In the example of FIG. 1 the portable device 100 comprises earbuds.

Each of the earbuds can comprise one or more loudspeakers that can be used playback audio content to the user 104. Other types of portable device 100 could also comprise other types of output means. For instance, the portable device 100 could be a head mounted display that could comprise one or more displays for presenting information to the user 104. The head mounted display could be used to provide both visual and audio outputs to the user 104.

The portable device 100 can also comprise one or more microphones. The microphones can be configured to detect sound signals. For instance, the earbuds shown in FIG. 1 could comprise a microphone in each of the earbuds.

The microphones of the portable device 100 can be configured to enable the location of a sound source to be determined. In some examples a portable device 100 can comprise multiple microphones or a microphone array. For instance, headphones or a head mounted display could comprise multiple microphones. In some examples multiple portable devices 100 could each comprise a single microphone and the signals detected from the microphones in the different portable devices 100 can be used to analyze the location of a sound source. For instance, each of the earbuds can be a separate portable device 100 and each ear bud can comprise a single microphone.

The portable device 100 also comprises one or more transceivers that enables the portable device 100 to connect or pair with one or more of the candidate devices 102. The connection or pairing can comprise a wireless communication link. The wireless communication link could use any suitable wireless protocol such as Bluetooth, Bluetooth Low Energy, Bluetooth Smart, 6LoWPan (IPᵥ6 over low power personal area networks) ZigBee, ANT+, near field communication (NFC), Radio frequency identification, wireless local area network (wireless LAN) or any other suitable protocol.

In the scenario shown in FIG. 1 there are multiple candidate devices 102A-102D that the portable device 100 can be connected to. These could be candidate devices 102A-102D that are within the communication range of the portable device 100 or that are in the same area as the portable device 100.

In the example of FIG. 1 the user 104 is using the first candidate device 102A. the User 104 could be taking part in a teleconference using any other suitable type of content. In this case the user 104 wants to view images on the screen of the first candidate device 102A but wants to use the portable device 100 (or devices) to listen to the audio content. To do this the user 104 will need to connect the portable device 100 (or devices) to the correct candidate device 102A.

In this use case, there are multiple other candidate devices 102B-102C that the portable device 100 could be connected to. In the example of FIG. 1 three other candidate devices 102B-102D are shown however there could be any number of other candidate devices 102. In the example of FIG. 1 the second candidate device 102B is a mobile phone, the third candidate device 102C is a tablet computer, and the fourth candidate device 102D is another laptop computer. The mobile phone and the tablet computer could be associated with the first user 104. For example, they could belong to the user of the portable device 100. The fourth candidate device 102D could be associated with a different user 106. For instance, a family member, colleague or friend, could be using their devices in the same room as the first user 104.

When the user 104 starts to use the portable device 100 to listen to audio the portable device 100 can automatically connect to any of the candidate devices 102A-102D. For instance, the portable device 100 could connect to the user's mobile phone or tablet computer even if these are inactive. Such devices would often be close to the user 104, for instance a user's phone could be in their pocket but a laptop could be on their desk. In some cases, the portable device 100 could even connect to candidate devices associated with other users 106 such as the fourth candidate device 102D. This could occur if the portable device 100 has been previously paired with the fourth candidate device 102D, for example if the users 104, 106 have shared content together or have loaned each other devices.

It can be frustrating for the user 104 if the portable device 100 connects to the wrong candidate device 102. Examples of the disclosure address this issue and provide systems and methods for connecting portable devices 100 with the correct candidate device 102.

FIG. 2 shows an example method that can be used in examples of the disclosure. The method could be performed by an apparatus 600 such as the apparatus 600 shown in FIG. 6. The apparatus 600 could be provided within a portable device 100 or within any other suitable device.

The portable device 100 can be any device that can be used by a user 104 to playback content. The portable device 100 can be configured to provide audio outputs to the user 104 and/or to provide any other suitable type of outputs. The portable device 100 can comprise any suitable means for providing outputs to the user 104. The output means can comprise loudspeakers, displays and/or any other suitable means.

The portable device 100 can be portable in that it can be moved by the user 104. the portable device 100 can be moved by the user 104 while the portable device 100 is in use. In some examples the portable device 100 could be a wearable device. The wearable device could be worn on the user's head or arm or any other suitable part of their body. In some examples the wearable device could be a head mounted device that could be positioned on a use's head during use. In some examples the wearable device could comprise earbuds, a head mounted display, headphones or any other suitable type of device. In other examples the portable device 100 could comprise a device that can be carried in a user's hand or pocket, such as a smart phone or other similar device.

At block 200 the method comprises determining locations for two or more candidate devices 102. The candidate devices 102 can be any devices that can be paired or wirelessly connected to a portable device 100 to enable content or other information to be exchanged between the candidate device 102 and the portable device 100. The candidate devices 102 can be used to store or access content that can then be forwarded to the portable device 100 via the wireless communication link.

Any suitable means or processes can be used to determine the locations for the candidate devices 102. In some examples the locations can be determined using Bluetooth low energy protocols, received signal strengths, or any other suitable processes.

At block 202 the method comprises identifying two or more candidate devices 102 that satisfy location criteria.

The location criteria can be determined relative to one or more portable devices 100. For instance, a candidate device 102 can be determined to satisfy the location criteria if it is within a given distance of a portable device 100 or within an identified region, such as a room, that corresponds with the portable device 100. Other types of location criteria could be used in other examples.

In some examples the location criteria that are to be satisfied can be a proximity threshold to the portable device 100. In such cases the location criteria would be satisfied by any candidate devices 102 that are within a give distance for the portable device 100 or that are within a predefined area such as a room, that the portable device 100 is located in. The proximity threshold could be determined by the communication range of the portable device 100 or by any other suitable factor.

In some examples the location criteria that are to be satisfied can comprise a proximity threshold between respective candidate devices 102. For instance, if there are multiple candidate devices 102 within the area of the portable device 100 but one device is located much closer to the portable device 100 than all of the others then it could be assumed that the candidate device 102 that is closest to the portable device 100 is the one that is to be connected to the portable device 100. However, in some use cases there could be two or more candidate devices 100 that are located within a similar distance from the portable device 100. In such cases it cannot be assumed that the closest candidate device 102 is the one that is to be connected to the portable device 100. In this case simply selecting the device that is closest to the portable device 100 could cause the connection to be made to the wrong device. This could be avoided by identifying if two or more candidate devices 102 are close to each other and following the embodiments of the disclosure. In such cases, if two or more of the candidate devices are within a given distance of each other, the examples of the disclosure can be used to select which candidate device 102 is to be connected to the portable device 100.

The respective candidate devices 102 can be identified by determining an identification of the respective devices or by determining any other suitable information. The identification can comprise information that can be used to enable a wireless communication link to be established between the candidate device 102 and one or more portable devices 100.

At block 204 the method comprises, using microphones of at least one portable device 100 to determine a location of a sound source relative to the at least one portable device 100.

Two or more microphones of one or more portable devices 100 can be used to determined the location of the sound source. In some examples the microphones that are used to analyze the location of the sound source can be provided within a single portable device 100. For instance, a head mounted display or a smart phone can comprise multiple microphones and/or a microphone array. In some examples the microphones that are used to analyze the location of the sound source can be provided within multiple portable devices 100. For instance, if the user 104 is using earbuds, then each of the ear buds provide an individual portable device. A single microphone could be located in each of the ear buds so that the pair of microphones can be used to determine the location of a sound source. In such cases the distance between the earbuds would be determined before the sound signals are detected. The distance between the earbuds could be determined based on measurements of the user 104 or any other suitable information.

The sound source that is analyzed could be the loudest or dominant sound source in the area around the portable device 100 (or devices). In some use cases the dominant sound source could be a candidate device 102. For instance, if the candidate device 102 is providing an audio output, then this could be the sound source that is localized by the microphones.

Any suitable process, such as beamforming, can be used to determine the location of the sound source relative to the portable device 100 (or devices).

The location of the sound source that is determined can comprise the distance from the portable device 100, or other suitable reference point, to the sound source. In some examples the location of the sound source that is determined could be the distance and direction from the portable device 100.

At block 206 the method comprises comparing the location of the sound source as determined at block 204 with the respective locations for the two or more candidate devices 102. The locations of the candidate devices 102 can be determined when the candidate devices 102 are identified, or can be identified using any other suitable process. The comparing can comprise correlating the locations of the one or more sound sources with the locations of the candidate devices 102 to determine if there is a match or a substantial match.

At block 208 the method comprises selecting a candidate device 102 for connecting to the at least one portable device 100. The selection is made based, at least in part, on the comparison between the location of the sound source and the respective locations for the two or more candidate device 102. The selected candidate device 102 can be the candidate device 102 that has a location that matches, or substantially matches, the location of the identified sound source. The selected candidate device 102 can have the same or similar location as the identified sound source.

Once a candidate device 102 has been selected then the selected candidate device 102 is connected to the portable device 100 to enable the selected candidate device 102 to provide audio content, and/or any other suitable type of content to the at least one portable device 100. The connection between the portable device 100 and the selected candidate device 102 can be a wireless communication link. The wireless communication link can be established using any suitable wireless protocol such as Bluetooth, Bluetooth Low Energy, Bluetooth Smart, 6LoWPan (IPᵥ6 over low power personal area networks) ZigBee, ANT+, near field communication (NFC), Radio frequency identification, wireless local area network (wireless LAN) or any other suitable protocol. The wireless communication link enables pairing of the portable device 100 with the selected candidate device 102. Once the candidate device 102 has been selected the communication link can be established automatically without any further input from the user 104.

FIG. 3 shows an example use case scenario for examples of the disclosure. In this case the user 104 is using a first candidate device 102A to watch music videos. In this example the first candidate device 102A is a laptop. Other types of candidate devices 102 could be used in other examples.

The first candidate device 102A comprises speakers. Initially the speakers of the first candidate device 102A are providing an audio output 300. The first candidate device 102A is therefore a sound source that can be detected by microphones such as microphones located in a portable device 100.

In the scenario shown in FIG. 3 there are also other candidate devices 102B-102C that are located close to the first candidate device 102A. In this example a second candidate device 102B comprises a mobile phone. This could be mobile phone of the user 104. The second candidate device 102B could be active or inactive. In this example the third candidate device 102C comprises a table computer. The third candidate device 102C is being used to write or draw. A stylus 306 is being used to actuate a touch screen of the third candidate device 102C. The third candidate device 102C is not being used to generate any audio content. The third candidate device 102C could be used by a different user to the first candidate device 102A.

The user 104 of the first candidate device 102A decides that they would like to listen to the audio using one or more portable devices 100. In this case the portable devices are earbuds 302A, 302B. The earbuds comprise a right earbud 302A and a left earbud 302B. In use the right ear bud 302A can be positioned in the user's right ear and the left earbud 302B can be positioned in the user's left ear. The respective earbuds 302A, 302B can be different portable devices 100 in that they can function independently of each other.

When the user 104 starts to the use portable device 100, for example when the user 104 turns the portable device 100 on, the portable device 100 has to find the candidate device 102 that it should connect to. To do this the portable device 100 can identify the candidate devices 102A-102C that satisfy location criteria.

In this example the location criteria can be proximity criteria. The portable device 100 can identify the candidate devices 102 that satisfy the proximity criteria by being within a distance of the portable device 100. In some examples the candidate devices 102 that satisfy the proximity criteria could be the two closest candidate devices 102 to the portable device 100. Other location criteria could be used in other examples.

In the example of FIG. 3 the second candidate device 102B does not satisfy the location criteria. In this case the second candidate device 102B is not within the predefined distance of the portable device 100 that is required to satisfy the location criteria. This is indicated by the cross 304 in FIG. 3. Therefore, the second candidate device 102B can be ignored by the portable device 100 when the portable device 100 is selecting which candidate device 102 to connect to.

To select between the candidate devices 102 that satisfy the location criteria the portable device 100 uses information about the location of sound sources. To do this the portable device 100 analyses detected sounds to identify a location of a sound source.

The portable device 100 comprises microphones that can be used to detect sound signals and localize a sound source. In the example of FIG. 3 each of the earbuds 302A, 302B can comprise a microphone that can be used to analyze the positions of sounds sources around the user 104. The distance between the earbuds 302A, 302B can be determined based on measurements or can be obtained from any other suitable source.

In the example of FIG. 3 the microphones of the portable device 100 will detect the audio output 300 from the first candidate device 102A but will not detect any audio from the third candidate device 102C. The microphones can be used to determine or estimate a position of the sound source.

Once the location of the sound source has been determined the portable device can comprise the location of the sound source with the respective locations for first candidate device 102A and the third candidate device 102C. The second candidate device 102B can be ignored in this use case scenario because it does not satisfy the location criteria.

In this case the location of the sound source detected by the microphones will match, or substantially match, the location of the first candidate device 102A. The portable device 100 can therefore select the first candidate device 102A for connecting to the portable device 100. The location of the sound source does not match, or substantially match, the location of the third candidate device 102C and so the portable device 100 does not select the third candidate device 102C for connecting to the portable device 100.

Once a candidate device 102 has been selected by the portable device 100 the portable device 100 can be connected to the selected candidate device 102. The connection to the selected candidate device 102 can be made by establishing a wireless communication link between the portable device 100 and the selected candidate device 102. The wireless communication link can be established automatically without any further input from the user 104.

In the use case scenario of FIG. 3 the portable device 100 could use the location of the sound source to select the candidate device 102. In some examples the location of the sound source might not provide sufficient information to enable a candidate device 102 to be selected. For instance, there could be more than one sound source, or there could be a lot of back ground noise or there could be multiple candidate devices 102 very close to each other.

FIG. 4 shows an example method that can be used if the location of the sound source does not provide sufficient information to enable a candidate device 102 to be selected. The method could be performed by an apparatus 600 such as the apparatus 600 shown in FIG. 6. The apparatus 600 could be provided within a portable device 100 or within any other suitable device.

The method of FIG. 4 begins the same way as the method of FIG. 2. At block 400 two or more candidate devices 102 that satisfy location criteria are identified, at block 402 the microphones of at least one portable device 100 are used to determine a location of a sound source, and at block 404 the location of the sound source as determined at block 402 is compared with the respective locations for the two or more candidate devices 102. These method blocks can be the same or similar to blocks 202 to 206 as described above.

At block 406 it is determined whether a candidate device 102 has been detected by the microphones. That is, it is determined whether the location of the sound source determined at block 402 matches the location of a candidate device 102.

If it is determined that a candidate device 102 has been detected then the method proceeds to block 408 and the detected candidate device 102 is selected. Once a candidate device 102 has been selected then the selected candidate device 102 is connected to the portable device 100 to enable the selected candidate device 102 to provide audio content, and/or any other suitable type of content to the at least one portable device 100.

If it is determined that a candidate device 102 has not been detected then the method proceeds to block 410. It can be determined that a candidate device 102 has not been detected if there is not a sufficient match between the location of the detected sound source and the location of the candidate devices 102. This could be the case if the environment is noisy, for instance, if there is more than one candidate device 102 generating an audio output or if there is a lot of background noise. In some cases, it can be determined that a candidate device 102 has not been detected if two or more of the candidate devices 102 are very close to each other, in which case there could be matches or substantial matches between the location of the sound source and the location of two or more of the candidate devices 102. In such cases the portable device cannot select which candidate device 102 to connect to without some additional information.

At block 410 information from one or more additional sensors is obtained. The additional information from the one or more additional sensors can be used to resolve which of the candidate devices 102 should be selected so that the selection of the candidate device 102 can be based, at least in part, on additional information obtained from one or more additional sensors. The additional information can be used in addition to the location information of the candidate device 102 and the sound source. The additional information can be used if the location information is insufficient to enable a selection to be made.

The additional sensors that are used to obtain the additional information can comprise one or more cameras, one or more motion sensors, or any other suitable type of sensors.

In examples where the additional sensor comprises a camera, the camera could be located in one of the candidate devices 102. For instance, a camera in a laptop or mobile phone could be used to determine if the user 104 is facing in the direction of the camera or not. In some examples the camera could be located within the portable device 100 and could be used to determine the direction that the user 104 is facing or could detect any candidate device 102 in the direction that the user 104 is facing. For instance, if the portable device 100 is a head set then this could comprise one or more cameras that can be used to determine the direction that the user 104 is facing.

In examples where the additional sensor comprises one or more motion sensors these could be located within the portable device 100 or any other device that is located on the user 104. The motion sensors could comprise an inertial measurement unit (IMU) or any other suitable types of sensors or combinations of sensors. The one or more motion sensors can be used to determine the direction that the user 104 is facing. For instance, motion sensors within a head set can be used to determine the head position of the user 104 and from this the direction that the user 104 is facing can be determined.

At block 412 the method comprises using the information obtained from the additional sensors to select a candidate device 102. The candidate device could be one that is in the direction that the user 104 is facing or could be selected based on any other information. Once a candidate device 102 has been selected then the selected candidate device 102 is connected to the portable device 100 to enable the selected candidate device 102 to provide audio content, and/or any other suitable type of content to the at least one portable device 100.

FIG. 5 shows an example use case scenario that corresponds to the method of FIG. 4.

In this case the user 104 is using a first candidate device 102A to watch music videos. In this example the first candidate device 102A is a laptop. Other types of candidate devices 102 could be used in other examples.

The first candidate device 102A comprises speakers. Initially the speakers of the first candidate device 102A are providing an audio output 300. The first candidate device 102A is therefore a sound source that can be detected by microphones such as microphones located in a portable device 100.

In the scenario shown in FIG. 5 there are also other candidate devices 102B-102C that are located close to the first candidate device 102A. In this example a second candidate device 102B comprises a mobile phone. This could be mobile phone of the user 104. The second candidate device 102B could be active or inactive. In this example the third candidate device 102C comprises a table computer.

In the example of FIG. 5 the third candidate device 102C also comprises speakers and the speakers of the third candidate device 102C are also providing an audio output 500. This could be the case if the user of the third candidate device 102C is using the third candidate device 102C to listen to audio content or for any other suitable purpose. The third candidate device 102C is therefore another sound source that can be detected by microphones such as microphones located in a portable device 100.

The user 104 of the first candidate device 102A decides that they would like to listen to the audio using one or more portable devices 100. For instance, they might find the audio outputs of the third candidate device 102C distracting. In this case the portable devices are earbuds 302A, 302B. The earbuds comprise a right earbud 302A and a left earbud 302B. Other types of portable devices 100 can be used in other examples.

The portable device 100 has to find the candidate device 102 that it should connect to. To do this the portable device 100 can identify the candidate devices 102A-102C that satisfy location criteria. The location criteria can be proximity criteria or any other suitable type of criteria. In the example of FIG. 5 the second candidate device 102B does not satisfy the location criteria. This is indicated by the cross 304 in FIG. 5. Therefore, the second candidate device 102B can be ignored by the portable device 100 when the portable device 100 is selecting which candidate device to 102 to connect to.

The portable device 100 can then analyze detected sounds to identify a location of a sound source. However, in this case there are two sound sources because both the first candidate device 102A and the third candidate device 102C are providing audio outputs 300, 500. Therefore, in this case the portable device 100 cannot detect a candidate device 102 for selection based on the location of the sound sources. Therefore, the portable device 100 needs to obtain additional information from one or more additional sensors.

In the example of FIG. 5 both the first candidate device 102A and the third candidate device 102C comprise cameras 502A, 502C. The cameras 502A, 502C can be used to detect which of the candidate devices 102 the user 104 is looking at. In this case the camera 502A of the first candidate device 102A can detect that the user 104 is looking at the first candidate device 102A. Similarly, the camera of 502C of the third candidate device 102C can also detect that the user 104 is not looking at the third candidate device 102C. This information can then be used to select the first candidate device 102A for connecting to the portable device 100. Once a candidate device 102 has been selected by the portable device 100 the portable device 100 can be connected to the selected candidate device 102.

In the above-described examples, the portable devices 100 are earbuds. Other types of portable devices 100 could be used in other examples. For instance, the portable devices could be other types of wearable devices or could be devices that can be carried during use such as smart phones or other suitable user devices.

In the above-described examples, the connection between the portable device 100 and the selected candidate device 102 is used to enable audio content to be shared from the candidate device 102 to the portable device 100. The connection could be used for other purposes in other examples. For instance, other types of information could be exchanged between the respective devices.

Examples of the disclosure enable a portable device 100 to automatically select a candidate device 102 to connect to. By using information about location of the sound sources this reduces the chances of the incorrect candidate device 102 being selected and the portable device 100 connecting to the wrong candidate device 102.

FIG. 6 schematically illustrates an apparatus 600 that can be used to implement examples of the disclosure. In this example the apparatus 600 comprises a controller 602. The controller 602 can be a chip or a chip-set. The apparatus 600 can be provided within a portable device such as a wearable device or any other suitable type of device.

In the example of FIG. 6 the implementation of the controller 602 can be as controller circuitry. In some examples the controller 602 can be implemented in hardware alone, have certain aspects in software including firmware alone or can be a combination of hardware and software (including firmware).

As illustrated in FIG. 6 the controller 602 can be implemented using instructions that enable hardware functionality, for example, by using executable instructions of a computer program 608 in a general-purpose or special-purpose processor 604 that may be stored on a computer readable storage medium (disk, memory etc.) to be executed by such a processor 604.

The processor 604 is configured to read from and write to the memory 606. The processor 604 can also comprise an output interface via which data and/or commands are output by the processor 604 and an input interface via which data and/or commands are input to the processor 604.

The memory 606 stores a computer program 608 comprising computer program instructions (computer program code 610) that controls the operation of the controller 602 when loaded into the processor 604. The computer program instructions, of the computer program 608, provide the logic and routines that enables the controller 602. to perform the methods illustrated in the accompanying Figs. The processor 604 by reading the memory 606 is able to load and execute the computer program 608.

The apparatus 600 comprises:
at least one processor 604; and
at least one memory 606 storing instructions that, when executed by the at least one processor 604, cause the apparatus 600 at least to perform:
   determining 200 locations for two or more candidate devices 102;
   identifying 202 two or more candidate devices 102 that satisfy location criteria;
   using 204 microphones of at least one portable device 100 to determine a location of a sound source relative to the at least one portable device 100;
   comparing 206 the location of the sound source and respective locations for the two or more candidate devices 102; and
   selecting 208 a candidate device 102 for connecting to the at least one portable device 100 based, at least in part, on the comparison between the location of the sound source and the respective locations for the two or more candidate devices 102.

As illustrated in FIG. 6, the computer program 608 can arrive at the controller 602 via any suitable delivery mechanism 612. The delivery mechanism 612 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 608. The delivery mechanism can be a signal configured to reliably transfer the computer program 608. The controller 602 can propagate or transmit the computer program 608 as a computer data signal. In some examples the computer program 608 can be transmitted to the controller 602 using a wireless protocol such as Bluetooth, Bluetooth Low Energy, Bluetooth Smart, 6LoWPan (IPᵥ6 over low power personal area networks) ZigBee, ANT+, near field communication (NFC), Radio frequency identification, wireless local area network (wireless LAN) or any other suitable protocol.

The computer program 608 comprises computer program instructions for causing an apparatus 600 to perform at least the following or for performing at least the following:
determining 200 locations for two or more candidate devices 102;
identifying 202 two or more candidate devices 102 that satisfy location criteria;
using 204 microphones of at least one portable device 100 to determine a location of a sound source relative to the at least one portable device 100;
comparing 206 the location of the sound source and respective locations for the two or more candidate devices 102; and
selecting 208 a candidate device 102 for connecting to the at least one portable device 100 based, at least in part, on the comparison between the location of the sound source and the respective locations for the two or more candidate devices 102.

The computer program instructions can be comprised in a computer program 608, a non-transitory computer readable medium, a computer program product, a machine readable medium. In some but not necessarily all examples, the computer program instructions can be distributed over more than one computer program 608.

Although the memory 606 is illustrated as a single component/circuitry it can be implemented as one or more separate components/circuitry some or all of which can be integrated/removable and/or can provide permanent/semi-permanent/dynamic/cached storage.

Although the processor 604 is illustrated as a single component/circuitry it can be implemented as one or more separate components/circuitry some or all of which can be integrated/removable. The processor 604 can be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in FIGS. 2 and 5 can represent steps in a method and/or sections of code in the computer program 608. The illustration of a particular order to the blocks does not necessarily imply that there is a required or preferred order for the blocks and the order and arrangement of the blocks can be varied. Furthermore, it can be possible for some blocks to be omitted.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1-15. (canceled)

16. An apparatus comprising:
at least one processor; and
at least one memory storing instructions that, when executed by the at least one processor, cause the apparatus at least to perform:
determining locations for two or more candidate devices;
identifying two or more candidate devices that satisfy location criteria;
using microphones of at least one portable device to determine a location of a sound source relative to the at least one portable device;
comparing the location of the sound source and respective locations for the two or more candidate devices; and
selecting a candidate device for connecting to the at least one portable device based, at least in part, on the comparison between the location of the sound source and the respective locations for the two or more candidate devices.

17. An apparatus as claimed in claim 16 wherein a candidate device is selected if the location of the candidate device corresponds with the location of the sound source.

18. An apparatus as claimed in claim 16 wherein the candidate device is selected based, at least in part, on information obtained from one or more additional sensor.

19. An apparatus as claimed in claim 18 wherein the information obtained from the one or more additional sensor is used if there is not a sufficient match between the location of the sound source and the respective locations for the two or more candidate devices.

20. An apparatus as claimed in claim 19 wherein the one or more additional sensor comprises at least one of:
a camera; or
a motion sensor.

21. An apparatus as claimed in claim 16 wherein the apparatus is further caused to connect the selected candidate device to the at least one portable device to enable the selected candidate device to provide audio content to the at least one portable device.

22. An apparatus as claimed in claim 16 wherein the location criteria are determined relative to the at least one portable device.

23. An apparatus as claimed in claim 16 wherein the location criteria comprise at least one of:
a proximity threshold to the at least one portable device; or
a proximity threshold between respective candidate devices.

24. An apparatus as claimed in claim 16 wherein the at least one portable device is configured to provide audio outputs.

25. An apparatus as claimed in claim 16 wherein the at least one portable device is a wearable device.

26. An apparatus as claimed in claim 25 wherein the wearable device is at least one of:
ear buds;
a head mounted display; or
headphones.

27. A method comprising:
determining locations for two or more candidate devices;
identifying two or more candidate devices that satisfy location criteria;
using microphones of at least one portable device to determine a location of a sound source relative to the at least one portable device;
comparing the location of the sound source and respective locations for the two or more candidate devices; and
selecting a candidate device for connecting to the at least one portable device based, at least in part, on the comparison between the location of the sound source and the respective locations for the two or more candidate devices.

28. A method as claimed in claim 27 wherein a candidate device is selected if the location of the candidate device corresponds with the location of the sound source.

29. A method as claimed in claim 27 wherein the candidate device is selected based, at least in part, on information obtained from one or more additional sensor.

30. A method as claimed in claim 29 wherein the information obtained from the one or more additional sensor is used if there is not a sufficient match between the location of the sound source and the respective locations for the two or more candidate devices.

31. A method as claimed in claim 27 further comprising connecting the selected candidate device to the at least one portable device to enable the selected candidate device to provide audio content to the at least one portable device.

32. A method as claimed in claim 27 wherein the location criteria are determined relative to the at least one portable device.

33. A method as claimed in claim 27 wherein the location criteria comprise at least one of:
a proximity threshold to the at least one portable device; or
a proximity threshold between respective candidate devices.

34. A non-transitory computer readable medium comprising program instructions that, when executed by an apparatus, cause the apparatus to perform at least the following:
determining locations for two or more candidate devices;
identifying two or more candidate devices that satisfy location criteria;
using microphones of at least one portable device to determine a location of a sound source relative to the at least one portable device;
comparing the location of the sound source and respective locations for the two or more candidate devices; and
selecting a candidate device for connecting to the at least one portable device based, at least in part, on the comparison between the location of the sound source and the respective locations for the two or more candidate devices.

35. A non-transitory computer readable medium as claimed in claim 34 wherein a candidate device is selected if the location of the candidate device corresponds with the location of the sound source.
